(19) United States
(12) Patent Application Publication
(10) Pub. No.: US 2017/0349234 A1
(43) Pub. Date: Dec. 7, 2017

(54) BICYCLE CONTROL DEVICE

(71) Applicant: TH INDUSTRIES CO., LTD., TAICHUNG (TW)

(72) Inventor: Alfredo Sala, TAICHUNG (TW)

(21) Appl. No.: 15/173,719

(22) Filed: Jun. 6, 2016

(51) Int. Cl. B62K 23/06; B62M 25/00

(52) U.S. Cl. CPC B62K 23/06; B62M 25/00

(57) ABSTRACT

A bicycle control device includes a housing member disposed at a handlebar of a bicycle and a lever including a first portion pivotally connected to the housing member, a second portion connected to the first portion, and a third portion connected to the second portion. The shortest line between two opposite ends of the first portion forms a first long side, and a projection of the first long side on a first plane is parallel to a first extension direction. The shortest lines between two opposite ends of the second portion and those of the third portion form a second long side and a third long side, respectively; and projections of the second and third long sides on the first plane is parallel to a second extension direction and a third extension direction. An angle between the first extension direction and the second extension direction ranges from 8° to 15°.

### FIELD OF THE INVENTION

The present invention relates to a control device, and more particularly to a bicycle control device.

### BACKGROUND OF THE INVENTION

Basic structures of a bicycle generally include a frame system, a drivetrain system, a brake system, and other accessories and components. Bicycles are assemblies of more than two thousand bicycle components, and have been utilized as a tool of transportation. Designed based on ergonomic, air dynamical, physical and mechanical principles, bicycles are driven by human pedaling without fuels, and are thus environmental friendly, convenient, and useful for fitness training and transportation. Therefore, bicycles have become an indispensible product for people's leisure lives nowadays.

Typically, control device of a bicycle is adopted for controlling the brake or gearshift devices of the bicycle, and is installed on the handlebar of the bicycle with control cables extending therefrom. To facilitate gripping and maneuvering, the distance between the control device and the handlebar is designed based on the average palm size of the population and is typically made constant. However, as palm sizes vary from person to person, stiffness or discomfort of the muscles often occurs when gripping and maneuvering the control device during a long-distance bicycle ride.

### BRIEF SUMMARY OF THE INVENTION

Therefore, the present invention provides a bicycle control device to solve the aforementioned issue.

According to an embodiment of the present invention, the bicycle control device includes a housing member and a lever. The housing member is disposed at a handlebar. The lever includes a first portion, a second portion, and a third portion. The first portion is pivotally connected to the housing member, and has a first end and a second end; the shortest straight line between the first end and the second end forms a first long side, and a projection of the first long side on a first plane is parallel to a first extension direction. The second portion is connected to the first portion, and has a third end and a fourth end; the shortest straight line between the third end and the fourth end forms a second long side, and a projection of the second long side on the first plane is parallel to a second extension direction. The third portion is connected to the second portion, and has a fifth end and a sixth end; the shortest straight line between the fifth end and the sixth end forms a third long side, a projection of the third long side on the first plane is parallel to a third extension direction. The angle formed on the first plane between the first extension direction and the second extension direction falls within a range of 8° to 15°.

In an embodiment of the present invention, a shortest distance between a projection of the first end on the first plane and a projection of the sixth end on the first plane falls within a range of 149 mm to 155 mm.

In an embodiment of the present invention, a shortest distance between a projection of the first end on the first plane and a projection of the second end on the first plane falls within a range of 53 mm to 55 mm.

In an embodiment of the present invention, a shortest distance between a projection of the third end on the first plane and a projection of the fourth end on the first plane falls within a range of 39 mm to 44 mm.

In an embodiment of the present invention, a shortest distance between a projection of the fifth end on the first plane and a projection of the sixth end on the first plane falls within a range of 56 mm to 57 mm.

In an embodiment of the present invention, a shortest distance between a projection of the first end on the first plane and a projection of the second end on the first plane is D1, a shortest distance between a projection of the third end on the first plane and a projection of the fourth end on the first plane is D2, and 5/6>D2/D1>2/3.

In an embodiment of the present invention, a shortest distance between a projection of the first end on the first plane and a projection of the second end on the first plane is D1, a shortest distance between a projection of the first end on the first plane and a projection of the sixth end on the first plane is D, and 3>D/D1>2.5.

In an embodiment of the present invention, the angle between the first extension direction and the second extension direction falls within a range of 11° to 12°.

In an embodiment of the present invention, a sidewall of the lever or more particularly of the third portion comprises a control component for controlling a gearshift of the bicycle.

In an embodiment of the present invention, a brake of the bicycle is activated by the lever when the first portion pivots about the housing member and the third portion is close to the housing member.

In an embodiment of the present invention, the angle is formed to the right when the housing member is disposed at a right end of the handlebar, and the angle is formed to the left when the housing member is disposed at a left end of the handlebar.

In an embodiment of the present invention, the first plane faces the handlebar and is perpendicular to a horizon when the housing member is disposed at the handlebar.

In an embodiment of the present invention, the first extension direction is parallel to the third extension direction.

In an embodiment of the present invention, the first portion concaves toward the handlebar.

In an embodiment of the present invention, the second portion convexes away from the handlebar.

In an embodiment of the present invention, the third portion concaves toward the handlebar.

In sum, users of a bicycle with the bicycle control device according to the embodiments of the present invention can stably and comfortably grip the control device while riding and maneuvering the bicycle. Meanwhile, as the users can stably and naturally place their fingers on the lever without having to apply extra strength thereon, stiffness or discomfort of the hand muscles during prolonged bicycle rides is avoided, therefore providing improved comfort of riding to the bicycle users.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic three-dimensional view of a bicycle control device according to an embodiment of the present invention;

FIG. 2 is a schematic perspective view of the bicycle control device of FIG. 1;

FIG. 3 is a schematic side view of the bicycle control device of FIG. 1 when gripped by a user; and

FIG. 4 is a schematic side view of the bicycle control device of FIG. 1 when gripped by another user.

### DETAILED DESCRIPTION OF THE INVENTION

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

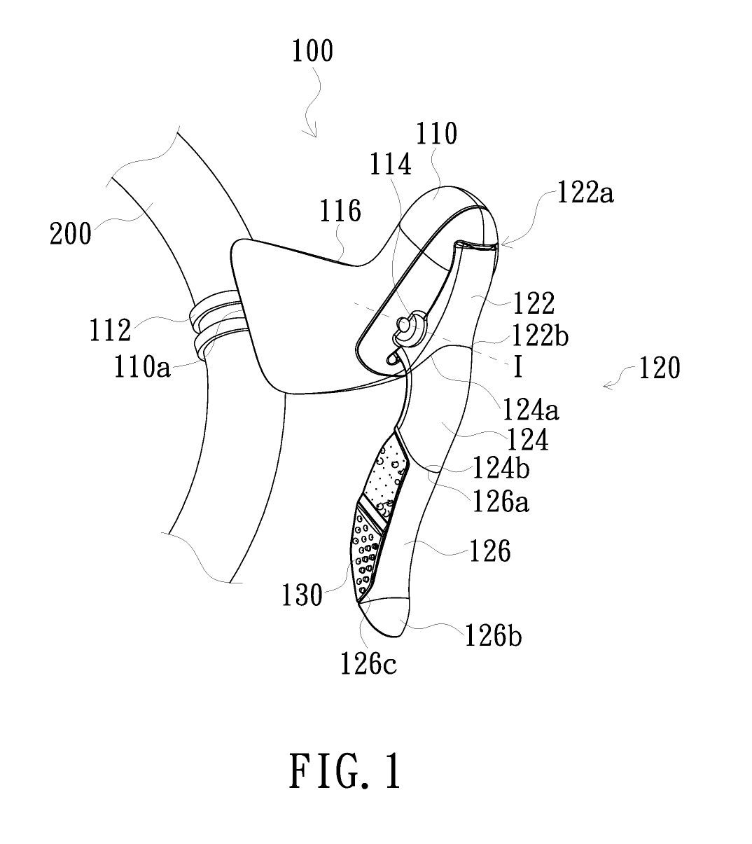

Referring now to FIG. 1. As illustrated in FIG. 1, a bicycle control device 100 of the present embodiment includes a housing member 110 and a lever 120.

The housing member 110 is disposed at a handlebar 200 of a bicycle. For example, the housing member 110 may include a connector 112 securable to the handlebar 200 for the bicycle control device 100 to be secured onto the handlebar 200. In the present embodiment, the connector 112 is an annular component disposed on a surface 110a of the housing member 110 away from the lever 120, and may sleeve through and be secured onto the handlebar 200. More specifically, after the connector 112 is secured onto the handlebar 200, a screw (not shown in figures) may be adopted to further fasten the connector 112 so that the connector 112 would tightly sleeve the handlebar 200. Additionally, the handlebar 200 may be a curved handlebar; for example, if a user is riding the bicycle with the housing member 110 disposed at the handlebar 200, the housing member 110 may extend outward and away from the user. If a curved handlebar 200 with its two opposite ends extending and bending away from the user is adopted, the housing member 110 of the bicycle control device 100 may be disposed at the bent portion of the handlebar 200.

It is to be understood that the bicycle control device 100 of the present embodiment is disposed at the right end of the handlebar 200 for the user to grip and maneuver with his/her right hand. It would be obvious to one of ordinary skill in the art to mirror-image the bicycle control device 100 of the present embodiment to obtain a bicycle control device to be disposed at the left end of the handlebar 200 for the user to grip and maneuver with his/her left hand. Therefore, features of a left-end bicycle control device are not to be repeated in this specification.

It is to be understood that the terms “left” and “right” mentioned herein are the positions of the handlebar 200 on which “left hand” and “right hand” of the user grip when the user rides the bicycle in a regular posture without crossing his/her arms.

The lever 120 includes a first portion 122, a second portion 124, and a third portion 126. The first portion 122 is pivotally connected to the housing member 110. The second portion 124 is connected to the first portion 122, and the third portion 126 is connected to the second portion 124. When the bicycle control device 100 is disposed at the handlebar 200, the first portion 122 concaves toward the handlebar 200 with a first radius of curvature of about 76 mm, the second portion 124 convexes away from the handlebar 200 with a second radius of curvature of about 525 mm, and the third portion 126 concaves toward the handlebar 200 with a third radius of curvature of about 80 mm. However, it is to be understood that the first, second and third radiuses of curvature are not limited thereto. Furthermore, the housing member 110 includes a pivot connector 114 pivotally connected to the first portion 122, so that the first portion 122 may pivot about the axis I in respect to the pivot connector 114 of the housing member 110. In the present embodiment, the first portion 122 may connect to a brake device (not shown in figures) of the bicycle; the lever 120 activate the brake device when the first portion 122 pivots about the housing member 110 and the third portion 126 moves toward the housing member 110. However, the present invention is not limited thereto.

The first portion 122 includes a first end 122a and a second end 122b opposite to the first end 122a. The second portion 124 includes a third end 124a and a fourth end 124b opposite to the third end 124a. The third portion 126 includes a fifth end 126a and a sixth end 126b opposite to the fifth end 126a. The first end 122a of the first portion 122 is partially disposed within the housing member 110. The third end 124a of the second portion 124 is connected to the second end 122b of the first portion 122, and the fifth end 126a of the third portion 126 is connected to the fourth end 124b of the second portion 124, therefore resulting in the lever 120 being in a substantially linear structure. The first portion 122, the second portion 124 and the third portion 126 may be, but are not limited to, formed into one integrated piece.

In the present embodiment, a sidewall of the lever 120 includes a control component 130 for controlling a gearshift device (not shown in figures) of the bicycle. More specifically, a sidewall 126c of the third portion 126 of the lever 120 includes the control component 130 for controlling gear shifting of the bicycle, and thus the engagement of a bicycle chain (not shown in figures) to a specific gear (not shown in figures). The control component 130 may be of a keystroke configuration, allowing the user to press the keys thereon to activate gear shifting. The sidewall 126c of the third portion 126 for disposing the control component 130 may be a surface of the outer wall of the third portion 126. It is to be understood that the outer wall mentioned herein refers to one of two opposite sidewalls of the third portion 126 facing away from the center of the handlebar 200 when the bicycle control device 100 is disposed at the handlebar 200.

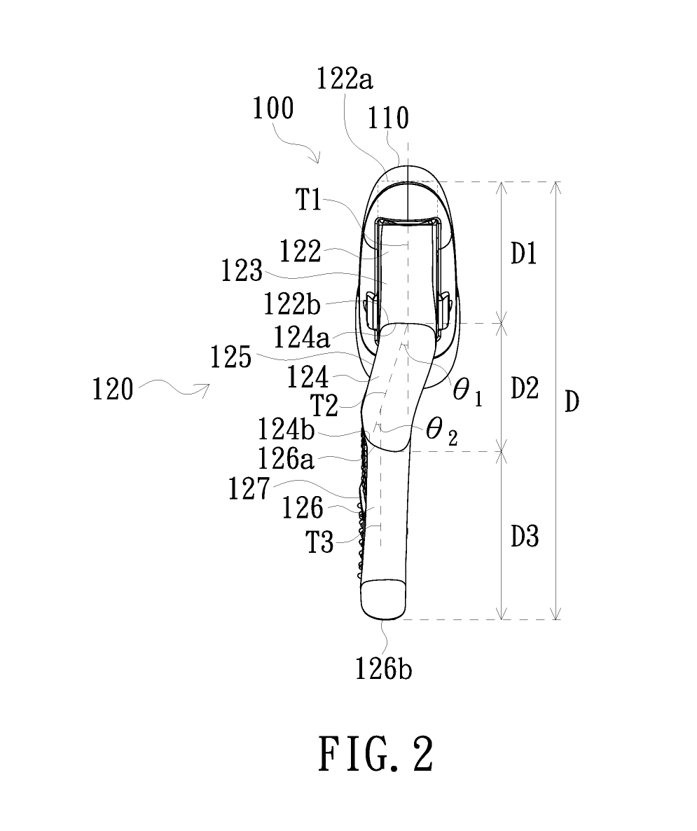

Referring now to FIG. 2 with FIG. 1. The viewing angle illustrated in FIG. 2 is a front view of the third portion 126 toward the housing member 110. As illustrated in FIGS. 1 and 2, the first portion 122 has a first end 122a and a second end 122b; the shortest straight line between the first end 122a and the second end 122b forms a first long side 123, and the projection of the first long side 123 on a first plane is parallel to a first extension direction T1. The second portion 124 has a third end 124a and a fourth end 124b; the shortest straight line between the third end 124a and the fourth end 124b forms a second long side 125, and the projection of the second long side 125 on the first plane is parallel to a second extension direction T2. Similarly, the third portion 126 has a fifth end 126a and a sixth end 126b; the shortest straight line between the fifth end 126a and the sixth end 126b forms a third long side 127, and the projection of the third long side 127 on the first plane is parallel to a third extension direction T3. The first long side 123 is connected to the second long side 125, and the third long side 127 is connected to the second long side 125. However, it is to be understood that the configuration of the three portions of the lever of the present invention is not limited thereto.

In the present embodiment, the first extension direction T1 and the second extension direction T2 form a first angle θ1 on the first plane, and the first angle θ1 falls within the range of 8° to 15°. For example, the first angle θ1 may vary within 8°-15° by an increment or decrement of 0.5° to form a plurality of embodiments. In some embodiments, the first angle θ1 may fall within the range of 11° to 12°, with an increment or decrement of 0.5° to form another plurality of embodiments.

Additionally, the first extension direction T1 may be, but is not limited to, parallel to the third extension direction T3. In other words, in the present embodiment, the second extension direction T2 and the third extension direction T3 form a second angle θ2 on the first plane when the first extension direction T1 is parallel to the third extension direction T3. The second angle θ2 falls within the range of 8° to 15°. For example, the second angle θ2 may vary within 8°-15° by an increment or decrement of 0.5° to form a plurality of embodiments. In some embodiments, the second angle θ2 may fall within the range of 11° to 12°, with an increment or decrement of 0.5° to form another plurality of embodiments.

In the present embodiment, the first portion 122 concaves toward the handlebar 200, the second portion 124 convexes away from the handlebar 200, and the third portion 126 concaves toward the handlebar 200.

Furthermore, the shortest distance D between the projection of the two opposite ends of the lever 120 (that is, the first end 122a of the first portion 122 and the sixth end 126b of the third portion 126) on the first plane falls within a range of 149 mm to 155 mm. The shortest distance D may vary within 149-155 mm by an increment or decrement of 0.5 mm to form a plurality of embodiments. In other words, the shortest distance D may be, but is not limited to, defined as the shortest distance between two parallel tangents to the first end 122a and the sixth end 126b.

The shortest distance D1 between the projection of two opposite ends of the first portion 122 (that is, the first end 122a and the second end 122b) on the first plane falls within the range of 53 mm to 55 mm. The shortest distance D1 may vary within 53-55 mm by an increment or decrement of 0.5 mm to form a plurality of embodiments. In other words, the shortest distance D1 may be, but is not limited to, defined as the shortest distance between two parallel tangents to the first end 122a and the second end 122b.

The shortest distance D2 between the projection of two opposite ends of the second portion 124 (that is, the third end 124a and the fourth end 124b) on the first plane falls within the range of 39 mm to 44 mm. The shortest distance D2 may vary within 39-44 mm by an increment or decrement of 0.5 mm to form a plurality of embodiments. In other words, the shortest distance D2 may be, but is not limited to, defined as the shortest distance between two parallel tangents to the third end 124a and the fourth end 124b.

The shortest distance D3 between the projection of two opposite ends of the third portion 126 (that is, the fifth end 126a and the sixth end 126b) on the first plane falls within the range of 56 mm to 57 mm. The shortest distance D3 may vary within 56-57 mm by an increment or decrement of 0.5 mm to form a plurality of embodiments. In other words, the shortest distance D3 may be, but is not limited to, defined as the shortest distance between two parallel tangents to the fifth end 126a and the sixth end 126b.

In some embodiments, the shortest distance D1 on the first portion 122 and the shortest distance on the second portion 124 satisfy the equation: 5/6>D2/D1>2/3, wherein D1 refers to the shortest distance between the projection of the two opposite ends of the first portion 122 (that is, the first end 122a and the second end 122b) on the first plane, and D2 refers to the shortest distance between the projection of the two opposite ends of the lever (that is, the first end 122a and the sixth end 126b) on the first plane.

It is to be understood that the aforementioned first plane may be a plane facing the handlebar 200 and perpendicular to the horizon when the housing member 110 is disposed at the handlebar 200. For example, the first plane may be a plane that is perpendicular to the horizon and includes the straight line between two symmetrical sixth ends 126b of two bicycle control devices 100 disposing on the left and right ends of the handlebar 200 (in other embodiments, the sixth ends 126b may be replaced by two symmetrical first ends 122a, two symmetrical second ends 122b, two symmetrical third ends 124a, two symmetrical fourth ends 124b, or two symmetrical fifth ends 126a). In the present embodiment, the first angle θ1 is formed to the right when the housing member 110 is disposed at the right end of the handlebar 200. Similarly, in other embodiments, the angle is formed to the left when the housing member 110 is disposed at the left end of the handlebar 200. It is to be understood that the terms “to the left” and “to the right” are referred to as based on the viewing angle of the user during riding in respect to the first plane. That is, the terms “left” and “right” are defined by viewing angles of the user and the positions of left and right hands of the user when riding the bicycle without crossing his/her arms.

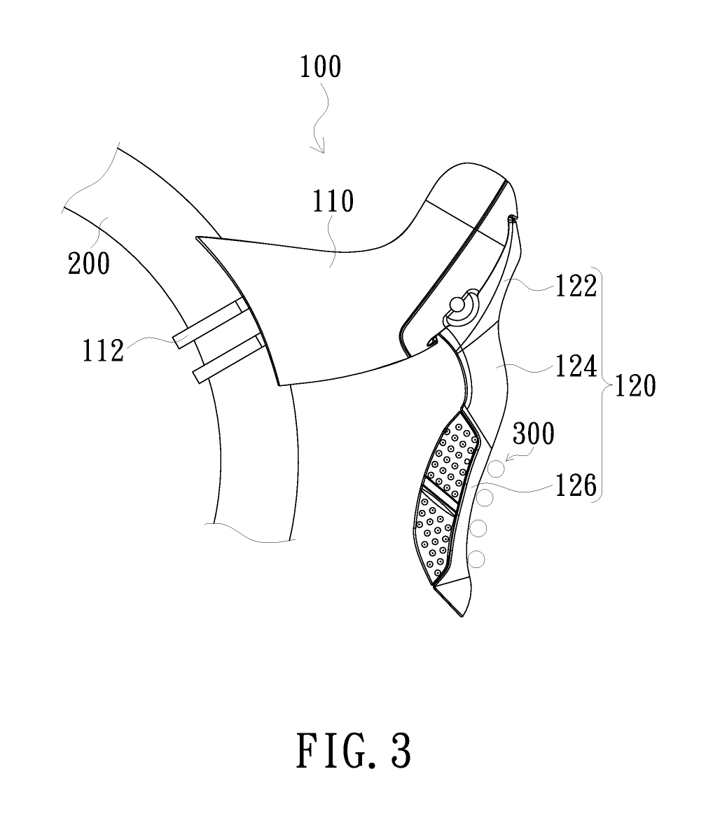

Referring now to FIG. 3. As illustrated in FIG. 3, the user may place his/her palm on the handlebar 200 and wrap around the handlebar 200 with his/her thumb and four other fingers 300 when riding the bicycle. To prepare for braking, the user may place at least one of the four fingers 300 around the third portion 126 of the lever 120, and press against the third portion 126 to drive the first portion 122 to pivotally rotate so as to activate the brake device of the bicycle. As the third portion 126 and the second portion 124 are unaligned (refer to FIG. 2), the size configuration of the third portion 126 and the second portion 124 allows better maneuverability when the user presses against the third portion 126 to activate braking. Meanwhile, as the user may stably and naturally place his/her fingers 300 on the third portion 126 without having to apply extra strength thereon, stiffness of the hands during riding may be avoided.

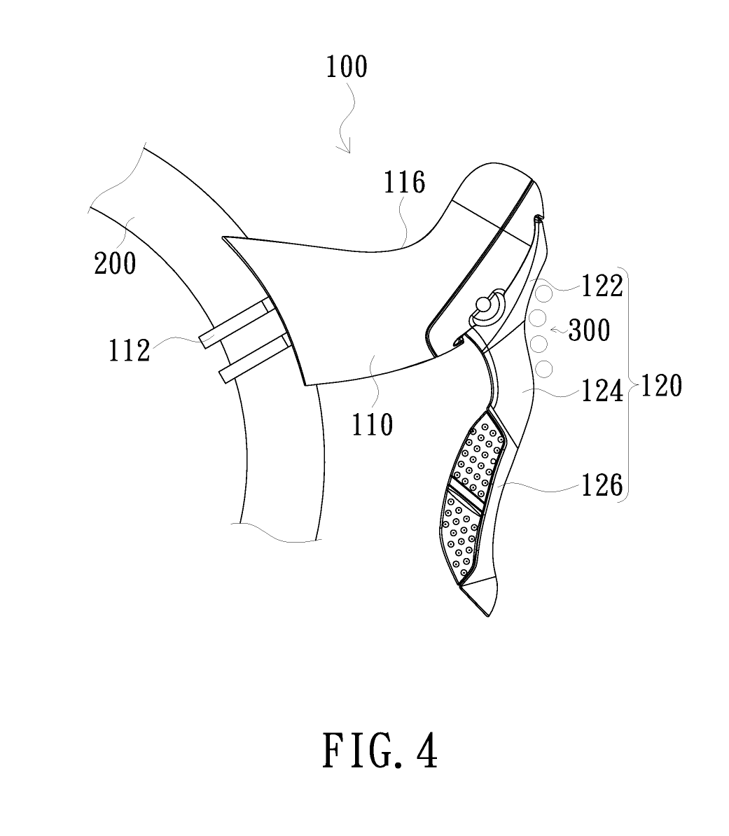

Referring now to FIG. 4. As illustrated in FIG. 4, the user may grip the handlebar 200 in another manner. More specifically, the user may grip the housing member 110 and place his/her palm on a bearing end 116 with his/her thumb placed at the inner side of the housing member 110. The four fingers 300 other than the thumb, or at least the ringer finger or the little finger, may substantially wrap around the housing member 110 during riding. To prepare for braking, the user may partially wrap around the first portion 122 and the second portion 124 with one or more of his/her four fingers 300 other than the thumb. As the first portion 122 and the second portion 124 are unaligned at a first angle θ1 (refer to FIG. 2), the bicycle control device 100 provides better maneuverability when the user presses against a portion of the first portion 122 and the second portion 124 to activate braking. Meanwhile, as the user may stably and naturally place his/her fingers 300 on the first portion 122 and the second portion 124 without having to apply extra strength thereon, stiffness of the hands during riding may be avoided.

According to the aforementioned embodiments, users of a bicycle with the bicycle control device of the present invention can stably and comfortably grip the control device while riding and maneuvering the bicycle. More specifically, configurations of the first, second and third portions of the lever allow the users to grip and press against the lever with less finger strength and better maneuverability. Additionally, as the users can stably and naturally place their fingers on the lever without having to apply extra strength thereon, stiffness or discomfort of the hand muscles during prolonged bicycle rides is avoided, therefore providing improved comfort of riding to the bicycle users.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bicycle control device, comprising:
a housing member, disposed at a handlebar of a bicycle; and
a lever, comprising:
a first portion, pivotally connected to the housing member, wherein the first portion has a first end and a second end, a shortest straight line between the first end and the second end forms a first long side, and a projection of the first long side on a first plane is parallel to a first extension direction;
a second portion, connected to the first portion, wherein the second portion has a third end and a fourth end, a shortest straight line between the third end and the fourth end forms a second long side, and a projection of the second long side on the first plane is parallel to a second extension direction; and
a third portion, connected to the second portion, wherein the third portion has a fifth end and a sixth end, a shortest straight line between the fifth end and the sixth end forms a third long side, a projection of the third long side on the first plane is parallel to a third extension direction, and an angle formed on the first plane between the first extension direction and the second extension direction falls within a range of 8° to 15°.

2. The bicycle control device according to claim 1, wherein a shortest distance between a projection of the first end of the lever on the first plane and a projection of the sixth end of the lever on the first plane falls within a range of 149 mm to 155 mm.

3. The bicycle control device according to claim 1, wherein a shortest distance between a projection of the first end of the first portion on the first plane and a projection of the second end of the first portion on the first plane falls within a range of 53 mm to 55 mm.

4. The bicycle control device according to claim 1, wherein a shortest distance between a projection of the third end of the second portion on the first plane and a projection of the fourth end of the second portion on the first plane falls within a range of 39 mm to 44 mm.

5. The bicycle control device according to claim 1, wherein a shortest distance between a projection of the fifth end of the third portion on the first plane and a projection of the sixth end of the third portion on the first plane falls within a range of 56 mm to 57 mm.

6. The bicycle control device according to claim 1, wherein a shortest distance between a projection of the first end of the first portion on the first plane and a projection of the second end of the first portion on the first plane is D1, a shortest distance between a projection of the third end of the second portion on the first plane and a projection of the fourth end of the second portion on the first plane is D2, and 5/6>D2/D1>2/3.

7. The bicycle control device according to claim 1, wherein a shortest distance between a projection of the first end of the first portion on the first plane and a projection of the second end of the first portion on the first plane is D1, a shortest distance between a projection of the first end of the lever on the first plane and a projection of the sixth end of the lever on the first plane is D, and 3>D/D 1>2.5.

8. The bicycle control device according to claim 1, wherein the angle between the first extension direction and the second extension direction falls within a range of 11° to 12°.

9. The bicycle control device according to claim 1, wherein a sidewall of the lever comprises a control component for controlling a gearshift of the bicycle.

10. The bicycle control device according to claim 1, wherein a sidewall of the third portion comprises a control component for controlling a gearshift device of the bicycle.

11. The bicycle control device according to claim 1, wherein a brake of the bicycle is activated by the lever when the first portion pivots about the housing member and the third portion is close to the housing member.

12. The bicycle control device according to claim 1, wherein the angle is formed to the right when the housing member is disposed at a right end of the handlebar, and the angle is formed to the left when the housing member is disposed at a left end of the handlebar.

13. The bicycle control device according to claim 1, wherein the first plane faces the handlebar and is perpendicular to a horizon when the housing member is disposed at the handlebar.

14. The bicycle control device according to claim 1, wherein the first extension direction is parallel to the third extension direction.

15. The bicycle control device according to claim 1, wherein the first portion concaves toward the handlebar.

16. The bicycle control device according to claim 1, wherein the second portion convexes away from the handlebar.

17. The bicycle control device according to claim 1, wherein the third portion concaves toward the handlebar.

18. A bicycle control device, comprising:
a housing member, disposed at a handlebar of a bicycle; and
a lever, comprising:
a first portion, pivotally connected to the housing member;
a second portion, connected to the first portion, wherein a shortest distance between two projections of two opposite ends of the first portion on a first plane perpendicular to a horizon is D1, a shortest distance between two projections of two opposite ends of the second portion on the first plane is D2, and 5/6>D2/D1>2/3; and
a third portion, connected to the second portion.

19. The bicycle control device according to claim 18, wherein a shortest distance between two projections of two opposite ends of the lever on the first plane is D, and 3>D/D1>2.5.
